(19) United States
(12) Patent Application Publication
(10) Pub. No.: US 2026/0070462 A1
(43) Pub. Date: Mar. 12, 2026

(54) METHOD AND APPARATUS FOR RECOMMENDING CHARGING STATION

(71) Applicant: HYUNDAI AUTOEVER CORP., Seoul (KR)

(72) Inventors: Lam LEE, Seoul (KR); Sung Jin KANG, Seoul (KR); Wang Gon YOO, Seoul (KR)

(21) Appl. No.: 19/312,880

(22) Filed: Aug. 28, 2025

(30) Foreign Application Priority Data
Sep. 9, 2024 (KR) 10-2024-0122173

(51) Int. Cl. B60L 53/68; G01C 21/34; G01C 21/36

(52) U.S. Cl. CPC B60L 53/68; G01C 21/3461; G01C 21/3469; G01C 21/3476; G01C 21/3691; B60L 2240/72

(57) ABSTRACT

Methods and apparatus for recommending a charging station are described. In one embodiment, the method comprises collecting data associated with a plurality of charging stations, generating, using the collected data, a feature set for each of one or more evaluation items, wherein the feature set includes one or more features associated with a corresponding evaluation item of the one or more evaluation items, generating scores for the plurality of charging stations by applying weights to the one or more features, and determining a recommended charging station based on the scores for the plurality of charging stations.

### CROSS-REFERENCE TO RELATED APPLICATION

This application claims priority from Korean Patent Application No. 10-2024-0122173 filed on Sep. 9, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and system for recommending a charging station, and more particularly, to a method for determining a recommended charging station based on a smart score and a system for performing the method.

### 2. Description of the Related Art

Selecting an appropriate electric vehicle charging station while driving is extremely important. For example, if a charging station visited via navigation guidance is found to be malfunctioning or in error, an unnecessary process of re-searching for another charging station may occur, potentially causing anxiety for the driver.

To address this, services exist that recommend charging stations based on evaluations from actual users. However, such evaluation information is subjective and unreliable, and when user feedback is unavailable, there is a lack of information. Furthermore, these services are limited in that they do not reflect the current driving situation of the user, making it difficult to recommend a charging station that is suitable for the user.

Therefore, there is a need for a method for recommending a charging station that provides objective evaluation information for each charging station while also reflecting the user's driving situation.

### SUMMARY

An objective of the present disclosure is to provide a method and system for recommending a charging station based on a charging station evaluation score derived using features representing the characteristics of the charging station.

Another objective of the present disclosure is to provide a method and system for recommending a charging station based on a charging station evaluation score that reflects the user's driving situation.

The objectives of the present disclosure are not limited to those mentioned above, and other objectives not explicitly stated will be clearly understood by those skilled in the art based on the following description.

According to an aspect of the present disclosure, there is provided a method for recommending a charging station, performed by a computing device. The method may comprise: collecting data associated with a plurality of charging stations; generating, using the collected data, a feature set for each of one or more evaluation items, wherein the feature set includes one or more features associated with a corresponding evaluation item; generating scores for the plurality of charging stations by applying weights to the one or more features; and determining a recommended charging station based on the scores for the plurality of charging stations, wherein the weights are dynamically determined based on a driving situation of a target vehicle.

In some embodiments, the collecting of the data may comprise: collecting charging station data from the plurality of charging stations, the charging station data including charging station information and charger information; and collecting vehicle data from navigation devices installed in vehicles, including the target vehicle, the vehicle data including route guidance history information and registration history information for the plurality of charging stations.

In some embodiments, the generating of the feature set may comprise: generating a first feature set for a first evaluation item representing charging station infrastructure, and the first feature set may include at least one feature among charging speed, 24-hour operation status, new installation status indicating whether each of the plurality of charging stations is newly installed, charger count, and floor level of each of the plurality of charging stations.

In some embodiments, the generating of the feature set may comprise: generating a second feature set for a second evaluation item representing an operational activity level of each of the plurality of charging stations, and the second feature set may include at least one feature among charger error information, charger repair time information, and charger failure count information.

In some embodiments, the generating of the feature set may comprise: generating a third feature set for a third evaluation item representing surrounding infrastructure of each of the plurality of charging stations, and the third feature set may include at least one feature among paid parking status and nearby amenity information.

In some embodiments, the generating of the feature set may comprise: generating a fourth feature set for a fourth evaluation item representing popularity of each of the plurality of charging stations, and the fourth feature set may include at least one feature among route guidance count and favorite registration count.

In some embodiments, the generating of the scores may comprise: determining the weights for the one or more features; generating scores for each of the evaluation items using a linear weighted summation method based on the determined weights; and generating the scores for the plurality of charging stations by normalizing the scores for each of the evaluation items within a predefined range.

In some embodiments, the determining of the weights may comprise: setting initial weights using a distribution of data associated with the one or more features and user preference information of the target vehicle; and adjusting the initial weights based on a current driving situation of the target vehicle.

In some embodiments, the adjusting of the initial weights may comprise adjusting the initial weights based on estimated arrival time information for a destination set in the navigation device installed in the target vehicle and driving history information for the destination.

In some embodiments, the adjusting of the initial weights may comprise adjusting the initial weights based on type information of a destination set in the navigation device installed in the target vehicle.

In some embodiments, the adjusting of the initial weights may comprise adjusting the initial weights based on road type information for a road on which the target vehicle is currently driving.

In some embodiments, the adjusting of the initial weights may comprise adjusting the initial weights based on current time information.

In some embodiments, the determining of the recommended charging station may comprise excluding, from among the plurality of charging stations, charging stations whose distance from a current location of the target vehicle exceeds a drivable range of the target vehicle.

In some embodiments, the determining of the recommended charging station may comprise excluding, from among the plurality of charging stations, charging stations for which an estimated arrival time of the target vehicle exceeds their operating hours.

According to the aforementioned and other embodiments of the present disclosure, there is provided an apparatus for recommending a charging station, comprising: at least one processor; and a memory storing one or more instructions. The at least one processor may be configured to, by executing the stored one or more instructions, perform operations of: collecting data associated with a plurality of charging stations; generating, using the collected data, a feature set for each of one or more evaluation items, wherein the feature set includes one or more features associated with a corresponding evaluation item; generating scores for the plurality of charging stations by applying weights to the one or more features; and determining a recommended charging station based on the scores for the plurality of charging stations, and the weights may be dynamically determined based on a driving situation of a target vehicle.

In some embodiments, the operation of collecting the data may comprise: collecting charging station data from the plurality of charging stations, the charging station data including charging station information and charger information; and collecting vehicle data from navigation devices installed in vehicles, including the target vehicle, the vehicle data including route guidance history information and registration history information for the plurality of charging stations.

In some embodiments, the operation of generating the feature set may comprise: generating a first feature set for a first evaluation item representing charging station infrastructure, and the first feature set may include at least one feature among charging speed, 24-hour operation status, new installation status indicating whether each of the plurality of charging stations is newly installed, charger count, and floor level of each of the plurality of charging stations.

In some embodiments, the operation of generating the feature set may comprise: generating a second feature set for a second evaluation item representing an operational activity level of each of the plurality of charging stations, and the second feature set may include at least one feature among charger error information, charger repair time information, and charger failure count information.

In some embodiments, the operation of generating the feature set may comprise: generating a third feature set for a third evaluation item representing surrounding infrastructure of each of the plurality of charging stations, and the third feature set may include at least one feature among paid parking status and nearby amenity information.

In some embodiments, the operation of generating the scores may comprise: determining the weights for the one or more features; generating scores for each of the evaluation items using a linear weighted summation method based on the determined weights; and generating the scores for the plurality of charging stations by normalizing the scores for each of the evaluation items within a predefined range.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a diagram illustrating an environment in which a system for recommending a charging station according to an embodiment of the present disclosure may be applied;

FIG. 2 is a diagram illustrating an environment for data collection of the system of FIG. 1;

FIG. 3 is a diagram for explaining the configuration of an apparatus for recommending a charging station according to an embodiment of the present disclosure;

FIG. 4 is a diagram illustrating evaluation items and features corresponding to the evaluation items according to an embodiment of the present disclosure;

FIGS. 5 through 7 are diagrams for explaining an operation for dynamically adjusting weights, which can be referenced in some embodiments of the present disclosure;

FIG. 8 is a flowchart of a method for recommending a charging station according to an embodiment of the present disclosure;

FIG. 9 is a detailed flowchart of some operations explained with reference to FIG. 8; and

FIG. 10 is a block diagram illustrating the hardware configuration of a computing device according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

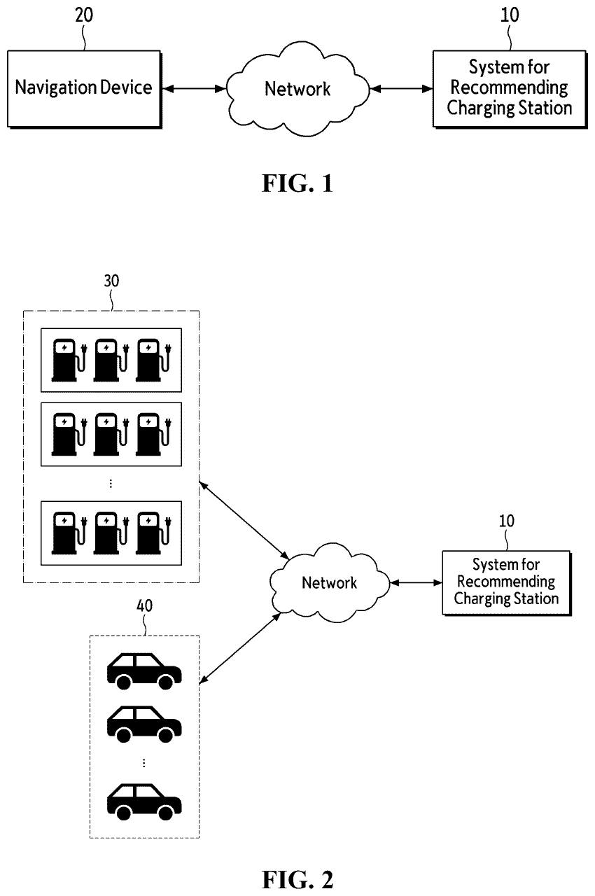

FIG. 1 illustrates an environment in which a system for recommending a charging station according to an embodiment of the present disclosure may be applied. As illustrated in FIG. 1, a system 10 for recommending a charging station may interact with a navigation device 20 to perform a method for recommending a charging station according to some embodiments of the present disclosure.

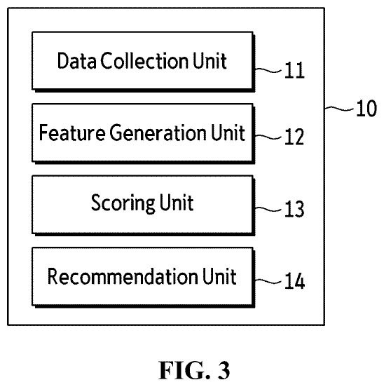

In this case, the system 10 may be understood as an entity performing the method according to an embodiment of the present disclosure and may also be understood as an apparatus for recommending a charging station according to an embodiment of the present disclosure. A detailed description thereof will be provided below with reference to FIG. 3. However, for convenience of explanation, the present disclosure will describe the system 10 as a single entity combined with a computing device.

Returning to FIG. 1, the navigation device 20 is a device installed in a target vehicle (not illustrated) that serves as the recipient of recommended charging station information from the system 10, and may perform a function of displaying information on the recommended charging station received from the system 10. In one embodiment, the navigation device 20 may acquire driving information of the target vehicle in which the navigation device 20 is installed. Here, the driving information of the target vehicle may include past driving history information and current driving state information. In one embodiment, the navigation device 20 may determine the current driving situation of the target vehicle using the driving information of the target vehicle.

Meanwhile, although the navigation device 20 has been described as a system separate from the target vehicle, in some embodiments, the navigation device 20 and the target vehicle may be configured in a stand-alone manner within a single system. In this case, operations performed by the navigation device 20 may be understood as being performed by the target vehicle.

The system 10 may determine a recommended charging station using data associated with a plurality of charging stations and may provide information on the recommended charging station to the navigation device 20 via a network. Specifically, the system 10 may collect data associated with the plurality of charging stations and generate a feature set for each of one or more evaluation items using the collected data. The system 10 may apply weights to one or more features to generate a score for each of the plurality of charging stations and may determine a recommended charging station based on the scores of the plurality of charging stations.

Hereinafter, a system environment for acquiring data associated with a plurality of charging stations in the system 10 will be described.

FIG. 2 illustrates an environment for data collection of the system of FIG. 1.

As illustrated in FIG. 2, the system 10 may acquire data from a plurality of charging stations 30 and a plurality of vehicles 40 including the target vehicle, either in real time or periodically. Specifically, the system 10 may acquire charging station data including information on the charging stations 30, information on chargers installed in the charging stations 30, and information on the environment surrounding the charging stations 30 from the charging stations 30. The system 10 may also acquire, from the vehicles 40, including the target vehicle, or from navigation devices installed in the vehicles 40, vehicle data including route guidance history information on the charging stations 30 and registration history information on the charging stations 30.

Meanwhile, the system 10 may be configured using one or more computing devices. For example, the system 10 may be configured using one or more cloud compute instances. That is, the system 10 may be configured using at least some compute instances among one or more virtual machines and one or more containers. Additionally, the system 10 may be configured to include both on-premise physical servers and the cloud compute instances.

Further, the components illustrated in FIGS. 1 and 2 may communicate with one another via a network. For example, the network may be implemented using any type of wired or wireless network such as a Local Area Network (LAN), a Wide Area Network (WAN), a mobile radio communication network, or Wireless Broadband Internet (WiBro).

Thus far, an exemplary environment in which the system 10 may be applied has been described with reference to FIGS. 1 and 2. Hereinafter, as another embodiment of the present disclosure, the configuration of an apparatus capable of performing a charging station recommendation method will be described with reference to FIG. 3.

FIG. 3 is a diagram for explaining the configuration of a charging station recommendation apparatus according to an embodiment of the present disclosure. For convenience of explanation, the apparatus of FIG. 3 will be considered equivalent to the system 10 described in FIGS. 1 and 2, as an object to which a method for recommending a charging station according to an embodiment of the present disclosure is applied.

As illustrated in FIG. 3, an apparatus 10 for recommending a charging station may include a data collection unit 11, a feature generation unit 12, a scoring unit 13, and a recommendation unit 14. However, the components illustrated in FIG. 3 do not reflect all functions of the apparatus 10 and are not essential. Accordingly, the apparatus 10 may include more or fewer components than those illustrated.

Additionally, the components illustrated in FIG. 3 represent functionally distinguishable elements, and may be implemented in an integrated form in a physical environment. Further, each of the components may be implemented in a form divided into a plurality of sub-functional elements in an actual physical environment. For example, a first function of the scoring unit 13 may be implemented in a first computing device, and a second function of the scoring unit 13 may be implemented in a second computing device.

According to an embodiment of the present disclosure, the data collection unit 11 may perform a function of collecting data associated with charging stations. Here, the data associated with the charging stations may include information to be considered in evaluating the plurality of charging stations and may include charging station data acquired from the plurality of charging stations and vehicle data collected from vehicles.

In one embodiment, the charging station data may be information representing comprehensive characteristics of each of the plurality of charging stations and may include charging station information and charger information. The charging station information may include, for example, location, hours of operation, and date of commencement of operation of each charging station, and information on the surrounding environment of each charging station. The charger information may be detailed information on chargers installed within each charging station and may include, for example, charging capacity, charging speed, charging type, number of chargers, and status information of the chargers.

In one embodiment, the vehicle data may be information acquired from each vehicle equipped with a navigation device and may include route guidance history information on charging stations and registration history information on charging stations. Here, the registration information on charging stations may include information on charging stations registered by each user as favorites or information on charging stations registered as destinations.

The data collection unit 11 may collect the charging station data and vehicle data in real time. Alternatively, to reduce system load, the data collection unit 11 may collect the charging station data and vehicle data at preset intervals. By collecting and updating data in real time or at preset intervals in this manner, the accuracy of the data may be improved by promptly reflecting the latest information.

The data collection unit 11 may perform preprocessing on the collected data, such as handling missing values, outliers, and data normalization. For example, if a specific value is missing from the collected data, the data collection unit 11 may replace the missing value with an average or median value, or remove the row with the missing value. Accordingly, the accuracy and consistency of the collected data may be ensured.

According to an embodiment of the present disclosure, the feature generation unit 12 may perform a function of generating features (i.e., sub-features or evaluation indicators) for scoring upper-level evaluation items of each charging station using the data (i.e., charging station data and vehicle data) collected by the data collection unit 11. Here, the evaluation items serve as criteria for generating a smart score for each charging station and may include at least one of a first evaluation item, a second evaluation item, a third evaluation item, and a fourth evaluation item. In this case, the first evaluation item may represent charging station infrastructure, the second evaluation item may represent the level of operational activity of each charging station, the third evaluation item may represent the infrastructure surrounding each charging station, and the fourth evaluation item may represent the popularity of each charging station. The features corresponding to the evaluation items may represent meaningful characteristics or detailed evaluation indicators related to the respective evaluation items for calculating a score.

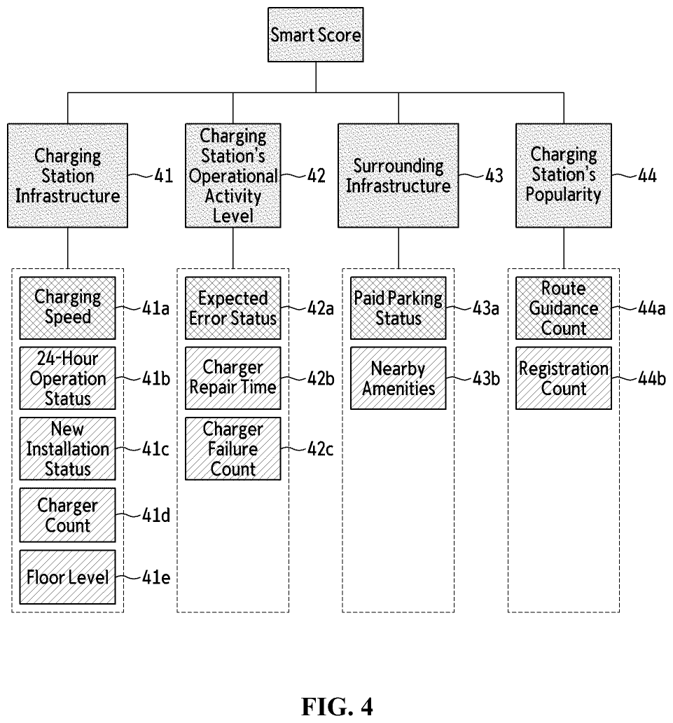

In one embodiment, the feature generation unit 12 may generate a feature set for each evaluation item. A detailed description of features (or a feature set) for each evaluation item will be provided below with reference to FIG. 4.

FIG. 4 shows evaluation items and features corresponding to the evaluation items according to an embodiment of the present disclosure.

As illustrated in FIG. 4, evaluation items for generating a smart score for a charging station may include charging station infrastructure (hereinafter, the first evaluation item) 41, the charging station's operational activity level (hereinafter, the second evaluation item) 42, the surrounding infrastructure (hereinafter, the third evaluation item) 43, which is a third evaluation item, and the charging station's popularity (hereinafter, the fourth evaluation item) 44, which is a fourth evaluation item.

The feature generation unit 12 may generate a first feature set for the first evaluation item 41. The first feature set may include at least one feature, for example, charging speed 41a, 24-hour operation status 41b, new installation status 41c indicating whether the charging station is newly installed 41c, charger count 41d of the charging station, and floor level 41e of the charging station. Here, the charging speed 41a, which represents the speed of chargers provided at the charging station, may include maximum charging speed, average charging speed, and the like of the chargers. The 24-hour operation status 41b may be determined using the operation time information provided by the charging station or may be determined using predicted actual operating hours based on usage logs or congestion levels of the charging station. The charger count 41d, which represents the number of chargers installed at the charging station, may include information on charger types and the number of chargers for each charger type. The floor level 41e may be used to evaluate accessibility to the charging station and may represent the location where the charging station is installed.

The feature generation unit 12 may generate a second feature set for the second evaluation item 42. The second feature set may include at least one feature, for example, anticipated error information 42a, repair time information 42b, and failure count 42c of the chargers installed at the charging station. The feature generation unit 12 may also generate a third feature set for the third evaluation item 43. The third feature set may include at least one feature and may include, for example, information 43a on whether parking is paid or free and nearby amenity information 43b.

The feature generation unit 12 may generate a fourth feature set for the fourth evaluation item 44. The fourth feature set may include at least one feature, for example, route guidance count 44a and registration count 44b, which represents the total number of times the charging station has been registered as a favorite or destination.

The first feature set for the first evaluation item 41, the second feature set for the second evaluation item 42, and the third feature set for the third evaluation item 43 may be generated using the aforementioned charging station data, and the fourth feature set for the fourth evaluation item 44 may be generated using the aforementioned vehicle data.

Meanwhile, the features described in FIG. 4 are illustrative, and other features may also be generated using the collected data. For example, features such as actual charging speed or aging level of each charger may be generated based on charging logs of actual users. In another example, features related to cost may be generated based on data regarding additional expenses such as charging fees and parking fees.

Referring again to FIG. 3, according to an embodiment of the present disclosure, the scoring unit 13 may apply weights to the features to generate a score for each of the plurality of charging stations.

In one embodiment, the scoring unit 13 may determine a weight for each of the features and apply the determined weight to generate a score for each evaluation item using a linear weighted summation method. In this case, the weight for each of the features may be dynamically determined based on the driving situation of the target vehicle. Specifically, the scoring unit 13 may set initial weights based the distribution of the data associated with the features and user preference information of the target vehicle, and may dynamically adjust the weights by adjusting the initial weights based on the current driving situation of the target vehicle.

Specifically, the initial weights may be determined by identifying the distribution status of data through statistics and distribution visualizations (e.g., histograms) of the data associated with the features, and further considering user preference information of the target vehicle. The user preference information may be determined using information such as charging station usage history, charging patterns, and charging station registration history of the user. In this manner, with the initial weights automatically set, the weights may be dynamically determined by increasing or lowering the initial weights based on the current driving situation of the target vehicle at the time of providing information on a recommended charging station.

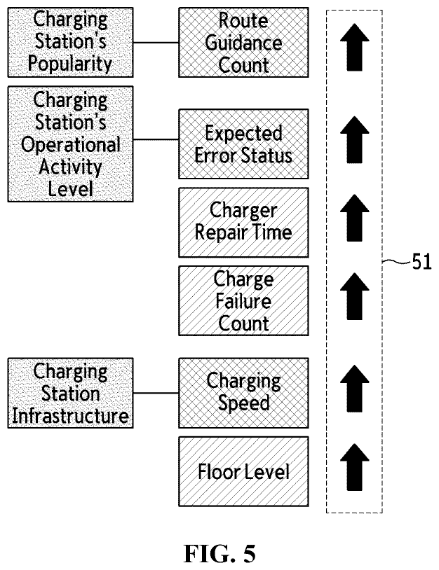

Hereinafter, specific examples of an operation for dynamically adjusting weights based on the driving situation of the target vehicle will be described with reference to FIGS. 5 through 7.

FIGS. 5 through 7 are diagrams for explaining an operation for dynamically adjusting weights, which may be referenced in some embodiments of the present disclosure.

First, FIG. 5 illustrates how to dynamically adjust weights in a first driving situation, where the target vehicle is driving to a distant destination that is not normally visited.

As illustrated in FIG. 5, if the estimated arrival time at the destination exceeds a threshold and there is no driving history for the destination, the current driving situation of the target vehicle may be determined to correspond to the first driving situation. In this case, the weights for the “route guidance count” feature for the “charging station's popularity” item, the “expected error status,” “charger repair time information,” and “charger failure count” features for the “charging station's operational activity level” item, and the “charging speed” and “floor level” features for the “charging station infrastructure” item may be adjusted upward, as indicated by reference numeral 51.

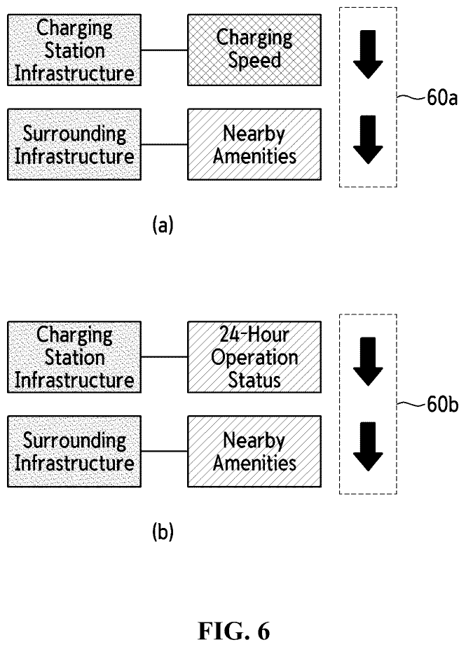

FIG. 6 illustrates how to adjust weights depending on the type of destination.

If the destination is an accommodation facility (e.g., a hotel, resort, etc.) and information on a recommended charging station is to be provided near the destination (see FIG. 6(a)), fast charging is not necessary. Accordingly, the weight for the “charging speed” feature for the “charging station infrastructure” item may be adjusted downward, as indicated by 60a, and since the destination is likely to include amenities, the weight for the “nearby amenities” feature for the “surrounding infrastructure” item may also be adjusted downward, as indicated by 60a.

If the destination is a shopping mall or complex facility (e.g., an outlet, mart, department store, amusement park, etc.) and information on a recommended charging station is to be provided near the destination (see FIG. 6(b)), the target vehicle may be expected to arrive within the operating hours of the charging station. Accordingly, the weight for the “24-hour operation status” feature for the “charging station infrastructure” item and the weight for the “nearby amenities” feature for the “surrounding infrastructure” item may be adjusted downward, as indicated by reference numeral 60b.

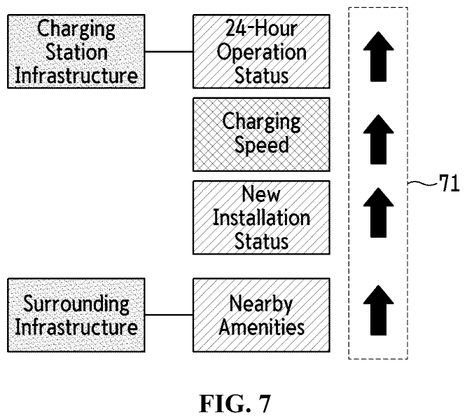

FIG. 7 illustrates how to dynamically adjust weights when driving on a highway or during late-night/early-morning hours. In this case, the weights for the “24-hour operation status,” “charging speed,” and “new installation status” features for the “charging station infrastructure” item, and the “nearby amenities” feature for the “surrounding infrastructure” item may be adjusted upward, as indicated by reference numeral 71.

Referring again to FIG. 3, the scoring unit 13 may normalize the scores for the respective evaluation items within a predefined range, thereby generating scores for the plurality of charging stations. For example, by applying min-max normalization, normalized scores for the plurality of charging stations may be generated in the range of 0 to 5.

The recommendation unit 14 may determine and provide a recommended charging station based on the scores generated by the scoring unit 13. The recommendation unit 14 may determine a charging station having a relatively high score as the recommended charging station, considering the user's current location, destination, and the like. In this case, charging stations whose distance from the current location of the target vehicle exceeds the driving range of the target vehicle may be excluded from the plurality of charging stations. Additionally, charging stations for which the estimated arrival time of the target vehicle exceeds their operating hours may also be excluded.

As described above, the configuration and operation of the system and the apparatus for recommending a charging station according to embodiments of the present disclosure have been explained. The charging station recommendation operation of the system/apparatus of the present disclosure may be further understood by referring to other embodiments to be described later. In addition, the technical idea of the system/apparatus of the present disclosure as understood from the above embodiments may also be reflected in other embodiments described below even if not explicitly stated.

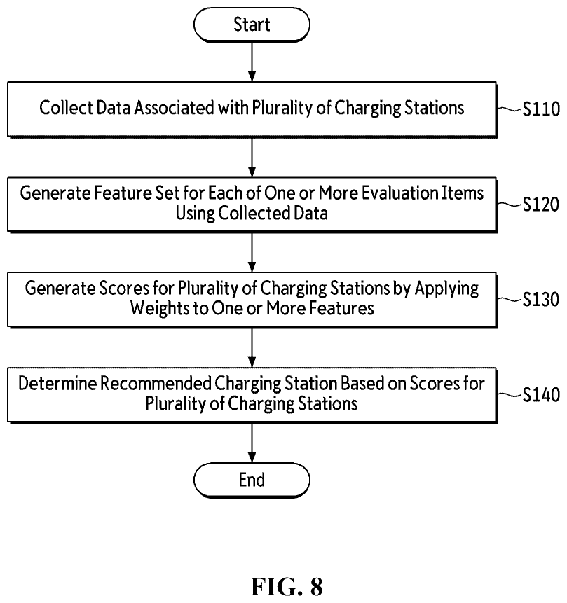

Hereinafter, a method for recommending a charging station according to an embodiment of the present disclosure will be described with reference to FIG. 8 and the subsequent drawings.

FIG. 8 is a flowchart of a method for recommending a charging station according to an embodiment of the present disclosure. The method for recommending a charging station according to an embodiment of the present disclosure may be performed by a system or apparatus for recommending a charging station. Accordingly, when the subject performing a specific step or operation is omitted, the step or operation may be understood as being performed by the system or apparatus for recommending a charging station. However, even if the subject of a specific step or operation is referred to as the system or apparatus for recommending a charging station, a navigation device may perform the step or operation depending on the implementation.

Referring to FIG. 8, in step S110, data associated with a plurality of charging stations may be collected. Specifically, charging station data from the plurality of charging stations may be collected, and vehicle data from navigation devices installed in a plurality of vehicles, including a target vehicle, may be collected. Here, the charging station data may include charging station information and charger information, and the vehicle data may include route guidance history information and registration history information for the plurality of charging stations.

Thereafter, in step S120, a feature set for each of one or more evaluation items may be generated using the data associated with the plurality of charging stations. Here, the feature set may include one or more features associated with the corresponding evaluation item.

For example, a first feature set may be generated for a first evaluation item representing the infrastructure of each charging station, and the first feature set may include at least one feature among charging speed, 24-hour operation status, new installation status indicating whether each charging station is newly installed, charger count, and installation floor level of each charging station. For example, a second feature set may be generated for a second evaluation item representing the operational activity level of each charging station, and the second feature set may include at least one feature among charger error information, charger repair time information, and charger failure count information. For example, a third feature set may be generated for a third evaluation item representing the surrounding infrastructure of each charging station, and the third feature set may include at least one feature among paid parking status and nearby amenity information. For example, a fourth feature set may be generated for a fourth evaluation item representing the popularity of each charging station, and the fourth feature set may include at least one feature among route guidance count and favorite registration count.

Thereafter, in step S130, weights may be applied to the respective features to generate scores for the plurality of charging stations. Here, the weights may be dynamically determined based on the driving situation of the target vehicle.

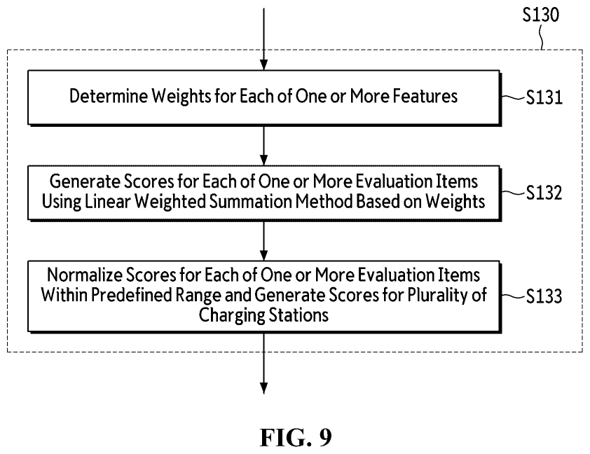

FIG. 9 is a detailed flowchart of some operations explained with reference to FIG. 8.

Referring to FIG. 9, step S130, which is the step of generating scores, may include determining weights for the respective features (S131), generating scores for each of the evaluation items (S132) using a linear weighted summation method based on the determined weights, and generating scores for the plurality of charging stations (S133) by normalizing the scores for each of the evaluation items within a predefined range.

Specifically, initial weights may be set using the distribution of data associated with the features and user preference information of the target vehicle, and may then be adjusted based on the current driving situation of the target vehicle. For example, the initial weights may be adjusted based on estimated arrival time information for a destination set in the navigation device installed in the target vehicle and driving history information for the destination. In another example, the initial weights may be adjusted based on type information of the destination set in the navigation device installed in the target vehicle. In yet another example, the initial weights may be adjusted based on road type information for the road on which the target vehicle is currently driving. In still another example, the initial weights may be adjusted based on current time information.

Referring again to FIG. 8, in step S140, a recommended charging station may be determined based on the scores for the plurality of charging stations. Specifically, charging stations that do not satisfy preset criteria may be excluded from among the plurality of charging stations, and among the remaining charging stations, a charging station having a relatively high score may be determined as the recommended charging station. For example, among the plurality of charging stations, those whose distance from the current location of the target vehicle exceeds the drivable range of the target vehicle may be excluded. In another example, among the plurality of charging stations, those for which the estimated arrival time of the target vehicle exceeds their operating hours may be excluded.

As described above, according to the present disclosure, by extracting features representing the characteristics of charging stations using data collected in real time or periodically and generating scores for each evaluation item using the features, objective evaluation information on charging stations may be provided. In addition, by dynamically determining weights for the features based on the user's driving situation, a charging station suitable for the user can be recommended, thereby improving user convenience.

Thus far, a method for recommending a charging station according to some embodiments of the present disclosure has been described with reference to FIGS. 1 through 9. The methods according to the embodiments of the present invention described above may be performed by execution of a computer program implemented in code readable by a computer. The computer program may be transmitted from a first computing device to a second computing device via a network such as the Internet and may be installed on the second computing device, and thereby used on the second computing device. Also, although operations are illustrated in the drawings in a specific order, it should not be understood that the operations must be performed in the illustrated or sequential order or that all the illustrated operations must be executed to achieve the intended result. In certain situations, multitasking and parallel processing may be advantageous.

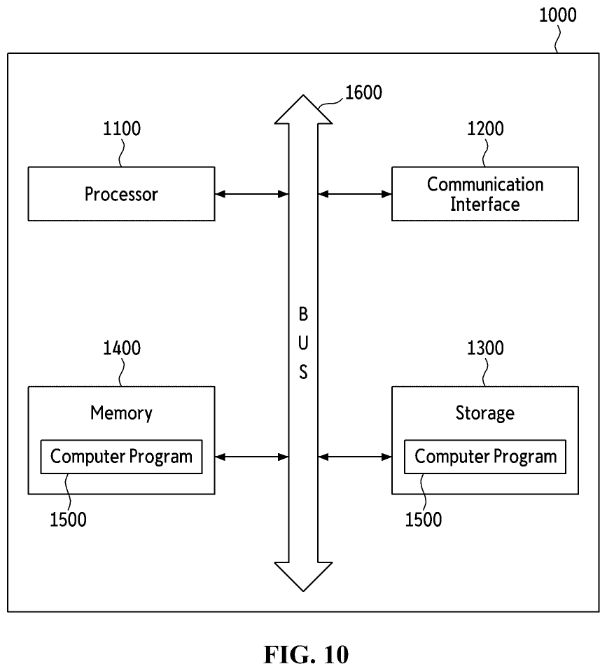

An exemplary computing device 1000 capable of implementing the aforementioned system/apparatus 10 will hereinafter be described with reference to FIG. 10.

FIG. 10 is a block diagram illustrating the hardware configuration of a computing device according to some embodiments of the present disclosure.

Referring to FIG. 10, a computing device 1000 may include at least one processor 1100, a bus 1600, a communication interface 1200, a memory 1400 that loads a computer program 1500 executed by the processor 1100, and a storage 1300 that stores the computer program 1500. However, since only components relevant to the embodiments of the present disclosure are illustrated in FIG. 10, one of ordinary skill in the art will recognize that other general-purpose components may also be included in addition to the components depicted in FIG. 10.

Additionally, in some embodiments, the computing device 1000 may be configured such that some of the components in FIG. 10 are omitted. The components of the computing device 1000 will hereinafter be described.

The processor 1100 may control the overall operation of each component of the computing device 1000. The processor 1100 may include at least one of a central processing unit (CPU), a micro processor unit (MPU), a micro controller unit (MCU), a graphics processing unit (GPU), or any type of processor well known in the relevant technical field of the present disclosure. The processor 1100 may also perform computations for at least one application or program for executing operations/methods according to various embodiments of the present disclosure. The computing device 1000 may include one or more processors 1100.

The memory 1400 may store various data, commands, and/or information. The memory 1400 may load the computer program 1500 from the storage 1300 in order to execute the operations/methods according to various embodiments of the present disclosure.

The bus 1600 may provide communication functionality between the components of the computing device 1000. The bus 1600 may be implemented as various types of buses, such as an address bus, a data bus, and a control bus.

The communication interface 1200 may support wired or wireless internet communication of the computing device 1000. Additionally, the communication interface 1200 may support various communication methods other than Internet communication. To this end, the communication interface 1200 may include a communication module well known in the technical field of the present disclosure.

The storage 1300 may non-transitorily store the computer program 1500. The storage 1300 may include a non-volatile memory such as read-only memory (ROM), erasable programmable ROM (EPROM), electrically erasable programmable ROM (EEPROM), flash memory, a hard disk, a removable disk, or any form of computer-readable recording medium well known in the technical field of the present disclosure.

The computer program 1500, when loaded into the memory 1400, may include one or more instructions that cause the processor 1100 to perform the operations/methods according to various embodiments of the present disclosure. That is, by executing the loaded one or more instructions, the processor 1100 may perform the operations/methods according to various embodiments of the present disclosure.

For example, the computer program 1500 may include instructions for performing the operations of: collecting data associated with a plurality of charging stations; generating, using the collected data, a feature set for each of one or more evaluation items, where the feature set includes one or more features associated with the corresponding evaluation item; generating scores for the plurality of charging stations by applying weights to the one or more features; and determining a recommended charging station based on the scores for the plurality of charging stations.

So far, a variety of embodiments of the present disclosure and the effects according to embodiments thereof have been mentioned with reference to FIGS. 1 to 10. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for recommending a charging station, performed by a computing device, the method comprising:
collecting data associated with a plurality of charging stations;
generating, using the collected data, a feature set for each of at least one evaluation item, wherein the feature set includes at least one feature associated with a corresponding evaluation item of the at least one evaluation item;
generating scores for the plurality of charging stations by applying weights to the at least one feature; and
determining a recommended charging station based on the scores for the plurality of charging stations,
wherein the weights are dynamically determined based on a driving situation of a target vehicle.

2. The method of claim 1, wherein the collecting of the data comprises: collecting charging station data from the plurality of charging stations, the charging station data including charging station information and charger information; and collecting vehicle data from navigation devices installed in vehicles including the target vehicle, the vehicle data including route guidance history information and registration history information for the plurality of charging stations.

3. The method of claim 1, wherein the generating of the feature set comprises: generating a first feature set for a first evaluation item representing a charging station infrastructure, and
wherein the first feature set includes at least one feature among a charging speed, a twenty four (24)-hour operation status, a new installation status indicating whether each of the plurality of charging stations is newly installed, a charger count, and a floor level of each of the plurality of charging stations.

4. The method of claim 1, wherein the generating of the feature set comprises: generating a second feature set for a second evaluation item representing an operational activity level of each of the plurality of charging stations, and
wherein the second feature set includes at least one feature among a charger error information, a charger repair time information, and a charger failure count information.

5. The method of claim 1, wherein the generating of the feature set comprises: generating a third feature set for a third evaluation item representing a surrounding infrastructure of each of the plurality of charging stations, and
wherein the third feature set includes at least one feature among a paid parking status and a nearby amenity information.

6. The method of claim 1, wherein the generating of the feature set comprises: generating a fourth feature set for a fourth evaluation item representing popularity of each of the plurality of charging stations, and
wherein the fourth feature set includes at least one feature among a route guidance count and a favorite registration count.

7. The method of claim 1, wherein the generating of the scores comprises: determining the weights for the at least one feature; generating evaluation scores for the each of the at least one evaluation item using a linear weighted summation method based on the determined weights; and generating the scores for the plurality of charging stations by normalizing the evaluation scores for the each of the evaluation items within a predefined range.

8. The method of claim 7, wherein the determining of the weights comprises: setting initial weights using a distribution of data associated with at least one feature and user preference information of the target vehicle; and adjusting the initial weights based on a current driving situation of the target vehicle.

9. The method of claim 8, wherein the adjusting of the initial weights comprises adjusting the initial weights based on estimated arrival time information for a destination set in a navigation device installed in the target vehicle and driving history information for the destination.

10. The method of claim 8, wherein the adjusting of the initial weights comprises adjusting the initial weights based on type information of a destination set in a navigation device installed in the target vehicle.

11. The method of claim 8, wherein the adjusting of the initial weights comprises adjusting the initial weights based on road type information for a road on which the target vehicle is currently driving.

12. The method of claim 8, wherein the adjusting of the initial weights comprises adjusting the initial weights based on current time information.

13. The method of claim 1, wherein the determining of the recommended charging station comprises excluding, from among the plurality of charging stations, each charging station whose distance from a current location of the target vehicle exceeds a drivable range of the target vehicle.

14. The method of claim 1, wherein the determining of the recommended charging station comprises excluding, from among the plurality of charging stations, each charging station for which an estimated arrival time of the target vehicle exceeds an operating hour of the each charging station.

15. An apparatus for recommending a charging station, comprising:
at least one processor; and
a memory storing a set of instructions,
wherein
the at least one processor, by executing the set of instructions, is configured to perform operations of:
collecting data associated with a plurality of charging stations;
generating, using the collected data, a feature set for each of at least one evaluation item, wherein the feature set includes at least one feature associated with a corresponding evaluation item of the at least one evaluation item;
generating scores for the plurality of charging stations by applying weights to the at least one feature; and
determining a recommended charging station based on the scores for the plurality of charging stations,
wherein the weights are dynamically determined based on a driving situation of a target vehicle.

16. The apparatus of claim 15, wherein the operation of collecting the data comprises: collecting charging station data from the plurality of charging stations, the charging station data including charging station information and charger information; and collecting vehicle data from navigation devices installed in vehicles including the target vehicle, the vehicle data including route guidance history information and registration history information for the plurality of charging stations.

17. The apparatus of claim 15, wherein the operation of generating the feature set comprises: generating a first feature set for a first evaluation item representing a charging station infrastructure, and
wherein the first feature set includes at least one feature among a charging speed, a 24-hour operation status, a new installation status indicating whether each of the plurality of charging stations is newly installed, a charger count, and a floor level of each of the plurality of charging stations.

18. The apparatus of claim 15, wherein the operation of generating the feature set comprises: generating a second feature set for a second evaluation item representing an operational activity level of each of the plurality of charging stations, and
wherein the second feature set includes at least one feature among a charger error information, a charger repair time information, and a charger failure count information.

19. The apparatus of claim 15, wherein the operation of generating the feature set comprises: generating a third feature set for a third evaluation item representing a surrounding infrastructure of each of the plurality of charging stations, and
wherein the third feature set includes at least one feature among a paid parking status and a nearby amenity information.

20. The apparatus of claim 15, wherein the operation of generating the scores comprises: determining the weights for the at least one feature; generating evaluation scores for the each of the evaluation items using a linear weighted summation method based on the determined weights; and generating the scores for the plurality of charging stations by normalizing the evaluation scores for the each of the evaluation items within a predefined range.
